(19) United States
(12) Patent Application Publication
(10) Pub. No.: US 2016/0243492 A1
(43) Pub. Date: Aug. 25, 2016

(54) AIR CONDITIONING DEVICE

(71) Applicant: Jeong Kyu PARK, Bucheon (KR)

(72) Inventor: Jeong Kyu PARK, Bucheon (KR)

(21) Appl. No.: 15/031,788

(22) PCT Filed: Oct. 17, 2014
(86) PCT No.: PCT/KR2014/009770

§ 371 Date: Apr. 25, 2016

(30) Foreign Application Priority Data
Oct. 24, 2013 (KR) 10-2013-0127104
Dec. 18, 2013 (KR) 10-2013-0157713

(51) Int. Cl. B01D 53/14; F24F 13/28; F24F 13/30

(52) U.S. Cl. CPC B01D 53/1431; F24F 13/30; F24F 13/28; F24F 2003/1614

(57) ABSTRACT

The present invention relates to an air conditioning device, and the purpose of the present invention is to provide an air conditioning device having a high thermal efficiency by filling a water tank with water and allowing air passing through a dry filter to flow into the water so as to secondarily filter the air, and by directly heating or cooling the water of the water tank. Thus, the present invention comprises: an air-blower fan for sucking outside air so as to discharge the outside air with pressure; a dry filter for primarily filtering and discharging the air discharged from the air-blower fan; and a water tank which accommodates water therein and receives the air passing through the dry filter in the water so as to secondarily filter the air by contacting the water, and which discharges, indoors, the air that rises up by passing through the water, wherein the inside of the water tank is provided with a heater for heating the water and a cooling coil for cooling the water.

### TECHNICAL FIELD

The present invention relates to an air conditioning device, and in particular to an air conditioning device wherein a dry filter primarily filters an outside air, and a wet filter secondarily filters the primarily filtered outside air, while the wet filter is simultaneously carrying out heating and cooling operations.

### BACKGROUND ART

The indoor space of a predetermined building is filled with an outside air which is externally inputted from the outside, wherein the outside air contains various micro-sized dusts, ordinary dusts, air contaminants, etc., and the inside air also contains micro-sized dusts, bad smell, bacteria, and various harmful substances which might be outputted from interior materials, while causing, for example, a sick house syndrome. The aforementioned various substances may have a bad effect to people's health.

Moreover, in case of the heating or cooling operation, a door or windows are closed so as to prevent any heat loss since the indoor air discharges to the outside. For this reason, the indoor air of the closed indoor space is not fresh and may be readily contaminated, and the concentration of oxygen in the indoor space may be lowered.

As an example to prevent any air contamination in the indoor space, the Korean patent laid-open No. 10-2012-0012146 the title of which is “a wet filtration type filter device for an air conditioning” is disclosed.

The configuration of the aforementioned conventional wet filtration type filter device for an air conditioning will be described. It includes a frame body 112 installed inside of an air conditioning, wherein both sides thereof are open so as to provide an air flow passage; filter elements 114 which are installed oblique with multiple stages inside of the frame body 112 and are employed to filter micro-sized dusts and ordinary dusts contained in the air which passes through the frame body 112; nozzles 116 which are installed near the filter elements 114 for the sake of a wet filtration which may be carried out in such a way that the micro-sized dusts and ordinary dusts filtered by the filter elements 114 come into contact with water drops and precipitate and are able to spray the water into the forms of fog in the moving direction of the air toward the filter elements 114; and a drain unit 118 which is installed at a lower portion of the frame body 112 so as to drain the water which has been sprayed toward the filter elements 114 via the nozzles 116.

The aforementioned conventional wet filtration type filter device for an air conditioning, however, may consume a lot of water since the water is sprayed via the nozzles 116 installed at the filter elements 114 which are arranged with multiple stages so as to filter micro-sized dusts and ordinary dusts, which may consequently cause a disadvantage.

A large capacity of an air blower fan should be inevitably used so as to allow the air to pass through the filter elements 114 which are installed with multiple stages. In this case, the water may fly away out of a desired range due to the pressure of the blowing air, which may interrupt an effective filtering, which may consequently cause a problem.

Since the sprayed water is continuously sprayed toward the filter elements 114, the micro-size dusts and ordinary dusts which have already contacted with the sprayed water, may come into contact with the filter elements 114, whereby the filter elements 114 may be contaminated. Various bacteria may grow at the contaminated portions, thus contaminating the indoor air, which may provide a bad effect to people's health.

Moreover, it needs to disassemble the filter elements 114 one by one so as to clean the contaminated filter elements 114, which may cause a complicated work. Such a cleaning work should be carried out by a technical expert, not an ordinary user, so maintenance is not easy.

### DISCLOSURE OF INVENTION

Accordingly, the present invention is made an effort to resolve the aforementioned problems. It is an object of the present invention to provide an air conditioning device which is able to secondarily filter air in such a way to fill water in a water tank and allow the air which has already passed through a dry filter, to flow into the water, and the water in the water tank is directly heated or cooled, thus providing a high heat efficiency to the air conditioning device.

It is another object of the present invention to provide an air conditioning device which is able to provide a high heat exchange efficiency in such a way that a heat exchange can be carried out with a heated or cooled water while the water which has passed through the dry filter, is passing through heat exchange part pipes which are disposed branched.

To achieve the above objects, there is provided an air conditioning device, which may include, but is not limited to,
an air-blower fan which is employed to suck an outside air and discharge the air with a predetermined pressure;
a dry filter which is employed to primarily filter the air discharged from the air-blower fan and then discharge the air; and
a water tank which is configured to store water therein and is able to secondarily filter the air by receiving, in water, the air which has passed through the dry filter, based on the contact with the water, thus discharging, into an indoor space, the air which is rising up after it has passed through the water.

Moreover, a heater for heating water and a cooling coil for cooling water are installed inside the water tank.

### ADVANTAGEOUS EFFECTS

According to the present invention, the ordinary dusts or micro-sized dusts contained in the air are primarily filtered by a dry filter, and the air is passed through water, thus eliminating any rests of the ordinary dusts or micro-sized dusts, bacteria, harmful gas, etc., whereby the indoor air can be maintained clean and fresh, and since the inputted air is passed through water, it can be possible to prevent over water consumption as compared to the conventional filtering method wherein water is sprayed.

Moreover, the cooling or heating operation can be carried out based on the changed temperature of the air which passes through water in such a way to directly heat or cool the water, whereupon the energy consumption can be minimized, thus providing more economical operations, as compared to the conventional method wherein air is directly heated.

It is advantageous that the inside can be readily cleaned by opening the cover of the water tank, for which maintenance is easy.

### BRIEF DESCRIPTION OF DRAWINGS

FIG. 1 is a view illustrating the configuration of a conventional wet filtration type filter device for an air conditioning.

FIG. 2 is a view illustrating the configuration of an air conditioning device according to the present invention.

FIG. 3 is a view illustrating the configuration of a filter member disposed inside of a water tank.

FIG. 4 is a view for describing another embodiment of the present invention.

FIG. 5 is a perspective view illustrating a heat exchange unit.

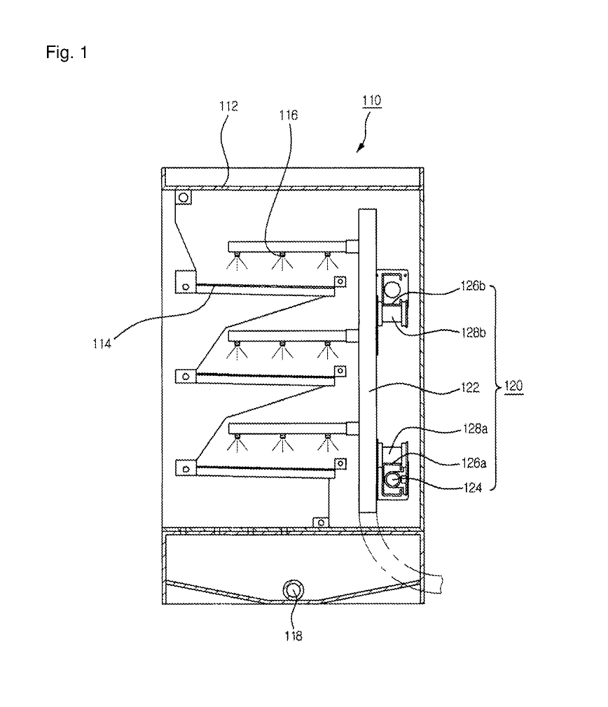

Legend of Reference Number

| | |
|---|---|
| 210: air-blower fan | 220: Dry filter |
| 221: Housing | 222: Filter member |
| 230: Air inflow pipe passage | 240: Water tank |
| 240-1: Cover | 241: Inflow port |
| 242: Outflow port | 244: Drain unit |
| 245: Valve | 246: Heater |
| 247: Cooling coil | 248: Bracket |
| 249: Filter member | 250: Cooling device |
| 260: Control panel | 270: Water temperature sensor |
| 330: Air inflow pipe | 340: Heat exchange unit |
| 341: Fixture | 342: Heat exchange pipe |

### BEST MODES FOR CARRYING OUT THE INVENTION

The present invention will be described with reference to the accompanying drawings.

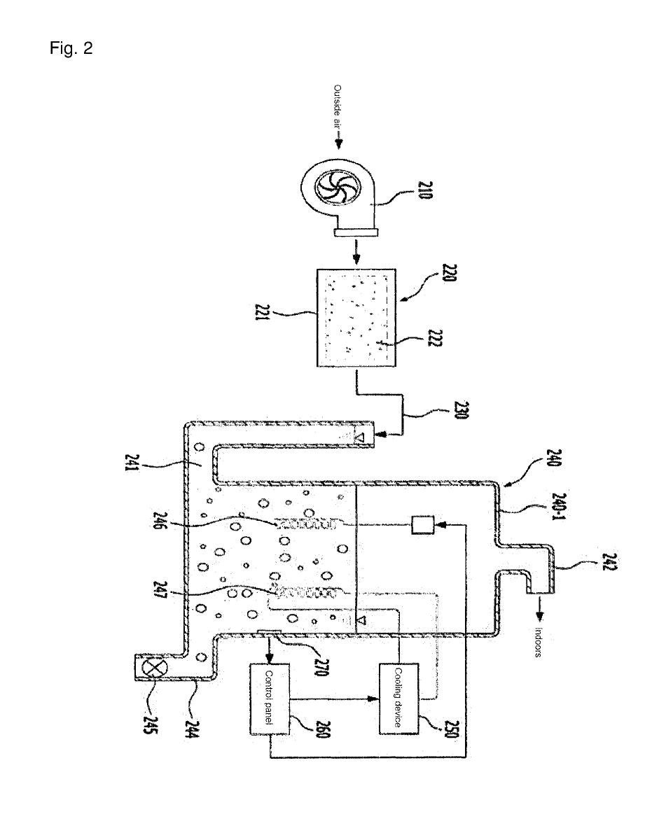

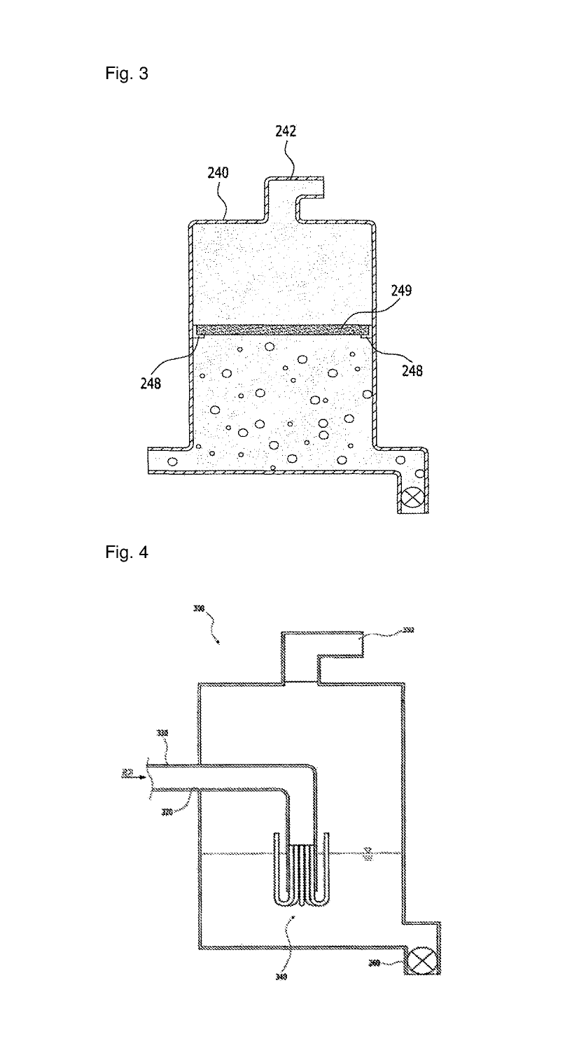

FIG. 2 is a view illustrating the configuration of an air conditioning device according to the present invention, which may include an air-blower fan 210, a dry filter 220, and a water tank 240.

The air-blower fan 210 is configured to suck an outside air and discharge by adding a pressure thereto. It may be formed of an ordinary air-blower fan, for example, a sirocco fan.

The ordinary dusts, micro-sized dusts, etc. contained in the air discharged from the air-blower fan 210 are eliminated by the dry filter 220. The dry filter 220 may accommodate a dry filter member 222, for example, a filter paper, a non-woven fabric, etc. the inside of a housing 221. The housing 221 may be made of a transparent material so as to visually check out the contamination levels of the filter member 222.

The air which has passed through the dry filter 220 will flow into the water tank 240 via the inflow pipe passage 230. The water tank 240 is filled with water. An inflow port 241 is installed at a lower portion of the water tank 240 so as to receive the air which has passed through the dry filter 220. The aforementioned inflow port 241 is disposed extending higher than the water level of the water tank 240 and is connected to the air inflow pipe passage 230.

The aforementioned configuration may allow the air to be easily inputted into water without any higher pressure, while contributing to the prevention of the reverse direction flow of the water toward the dry filter 220.

A drain unit 244 may be installed at a lower portion of the other side of the water tank 240 so as to discharge the stored water to the outside, and a valve 245 may be installed at the drain unit 244 so as to selectively discharge the water.

Moreover, an outflow port 242 is formed at an upper portion of the water tank 240 so as to discharge to the inside the air which has passed through the water.

Inside the water tank 240, an electric type underwater heater 246 for heating water and a cooling coil 247 for cooling the water are installed. Refrigerant flows through the cooling coil 247. The aforementioned refrigerant can be cooled by a cooling device 250 which operates with a typical cooling cycle.

The cooling device 250 may be configured in a typical structure which is formed of a refrigerant compression unit, an expansion unit, etc. The cooling coil 247 is employed to operate as a heat exchange unit.

The heater 246 and the cooling device 250 are configured to be driven in response to a control of the control panel 260. A water temperature sensor 270 is provided at the water tank 240. The control panel 260 will receive a temperature value of water from the water temperature sensor 270, thus controlling the heater 246 and the cooling device 250.

Moreover, a separable cover 240-1 is coupled to an upper portion of the water tank 240, whereupon the inside of the water tank 240 can be readily cleaned by separating the cover 240-1.

The operations of the present invention with the aforementioned configuration will be described.

If an external, which has been inputted via the air-blower fan 210, is inputted into the dry filter 220 together with a predetermined pressure, the ordinary dusts or micro-sized dusts, etc. are primarily filtered, and then are inputted into the water tank 240 via the air inflow pipe passage 230.

The air which has inputted into the water tank 240 will rise up in the form of air bubbles while it is passing through the water, and the secondarily filtering is carried out contacting with the water. Since the surface areas greatly increase with the aid of a lot of air bubbles, the contaminants can be efficiently absorbed by the water, thus maximizing the filtering effects. The fresh air which has been subjected to the secondarily filtering, will be inputted into the indoor space via the outflow port 242.

If the heat in the water tank 240 is heated up to 40˜50° C. by means of the heater 246, the temperature of the air inside the air bubbles contacting with the water will rise, and the air which is inputted into the indoor space will be heated warm, thus carrying out the heating operation. If the water is cooled down to 18˜25° C. by means of the cooling device 250 and the cooling coil 247, a cold air will be inputted into the indoor space, thus carrying out the cooling operation.

For the sake of the heating or cooling operation, if a user sets the temperature of the water by operating the control panel 260, the control panel 260 will receive a temperature value from the water temperature sensor 270 and will drive the heater 246 or the cooling device 250, thus heating or cooling the air with the aid of the water.

When it needs to clean the water tank 240, the water in the inside is discharged by opening the valve 245 of the drain unit 244. The cover 240-1, thereafter, is opened, and the cleaning can be carried out. And then, the valve 245 is closed, and water is filled into the water tank 240.

Since the water tank 240 is 30 cm in diameter and 50 cm high, which is not big, water of 20˜30 liters can be filled into the inside thereof, and then the filtering will be carried out, whereupon the water is not consumed a lot.

Meanwhile, since the air bubbles in the water rise up and burst on the water surface, the water may scatter over into the indoor space with the aid of bursting power.

In order to prevent the aforementioned phenomenon, the bracket 248 may be installed along the inner circumferences of the water tank 240 at the upper portions of the water surface, and a dry filter member 249 made of a nonwoven fabric, etc. may be installed at the bracket 248 in such a way to cover the inside of the water tank 240 in the horizontal direction.

Even though the water scatters over, the scattering water can be blocked by the filter member 249 and will not be inputted into the indoor space, and the filtering can be carried out again by the filter member 249, so a clean and fresh outside air can be inputted into the indoor space.

FIG. 4 is a view for describing another embodiment of the present invention. An air inflow pipe 330 is installed while passing through an upper side surface of the water tank 300. The aforementioned air inflow pipe 330 is formed bent downward from the inside of the water tank 300.

A heat exchange unit 340 is closely coupled to the bent lower portion of the air inflow pipe 330. The air inflow pipe 330 and the heat exchange unit 340 can be connected by various methods, for example, a welding method, a screw engaging method, a bonding method, etc.

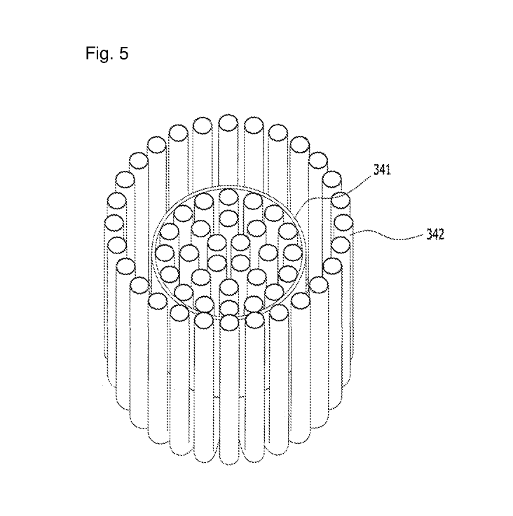

The heat exchange unit 340, as illustrated in FIG. 5, may include a cylindrical fixture 341 the upper and lower portions of which are open. A plurality of heat exchange pipes 342 each having a U-shaped metal pipe shape are engaged to the inner portions of the fixture 341. The heat exchange pipe 342 may be installed in such a way that one side thereof positions at an inner portion of the fixture 341, and the other side thereof is withdrawn toward a lower portion of the fixture 341 and positions at an outer portion of the fixture 341.

The heat exchange pipe 342 may be made of a metallic material, for example, copper, stainless steel, aluminum etc. which have a high heat conductivity and may be formed in a wrinkle pipe shape so as to increase a heat exchange surface area.

A plurality of the heat exchange pipes 342 which position at an inner portion of the fixture 341 are disposed dense, so they can be fixed stable in place with the aid of their dense powers, and otherwise there may be fixedly welded to each other, and the heat exchange pipes 342 which position at the edge portions may be fixed by a welding method or a bonding method to the fixture 341.

Moreover, the heat exchange pipes 342 which position at the outer portions of the fixture 341 may be disposed along the outer circumference of the fixture 341.

The water surface of the water in the water tank 300 may have a predetermined height high enough for the heat exchange pipes 342, which position at the outer portions of the fixture 341, not to be submerged in water, and as illustrated in FIG. 2, an electric type underwater heater 246 for heating water, a cooling coil 247 and a cooling device 250 for cooling water, and a water temperature sensor 270 for cooling water may be installed therein.

In this way, the air inputted having a predetermined pressure with the aid the air-blower fan 210 can be filtered by the dry filter 220, and will be inputted into the inside of the water tank 300 via the air inflow pipe 330, wherein the stream of the air may be divided into a plurality of the heat exchange pipes 342 of the heat exchange unit 340, and the air will be finally discharged above the water surface. Since the heated or cooled water contacts underwater with the heat exchange pipes 342, the air which passes through the insides of the heat exchange pipes 342, will exchange heat with the water, so it can be heated or cooled.

The air which has passed through the heat exchange pipes 342, will be discharged above the water surface in the water tank 300. Since the air in the water tank 300 is hot or cold by means of the heated or cooled water, the air which has passed through the heat exchange pipes 342, will exchange heat again with the air in the water tank 300, and then will be discharged into the indoor space via the outflow port 350.

The aforementioned configuration may contribute to maximizing the heat exchange efficiency in the water tank 300 while maximizing the heating or cooling efficiency.

1. An air conditioning device, comprising:
an air-blower fan which is employed to suck an outside air and discharge the air with a predetermined pressure;
a dry filter which is employed to primarily filter the air discharged from the air-blower fan and then discharge the air; and
a water tank which is configured to store water therein and is able to secondarily filter the air by receiving, in water, the air which has passed through the dry filter, based on the contact with the water, thus discharging, into an indoor space, the air which is rising up after it has passed through the water.

2. An air conditioning device, comprising:
an air-blower fan which is employed to suck an outside air and discharge the air with a predetermined pressure;
a dry filter which is employed to filter the air discharged from the air-blower fan and then discharge the air; and
a water tank which is configured to store water therein and is able to receive, above the water surface, the air which has passed through the dry filter, via an air inflow pipe, pass the air through a heat exchange unit installed underwater, discharge the air above the water surface and discharge the air into an indoor space.

3. The device of claim 2, wherein the heat exchange unit includes a fixture which is configured in a cylindrical shape the upper and lower sides of which are open, wherein an upper portion of the fixture is coupled to an end portion of the air inflow pipe, and one side of each a plurality of U-shaped heat exchange pipes is disposed at an inner portion of the fixture, and the heat exchange pipe extrudes via a lower portion of the fixture, and the other side thereof is disposed along an outer circumference of the fixture, and an end portion of the other side thereof positions above the water surface.

4. The device of claim 3, wherein the heat exchange pipe is formed in a wrinkle shape.

5. The device of claim 1, wherein a heater for heating water and a cooling coil for cooling water are installed inside the water tank.

6. The device of claim 1, wherein a drain unit is installed at the bottom of the water tank so as to discharge water.

7. The device of claim 1, wherein the dry filter is installed in such a way that a filter member is inserted in the inside of a housing which is made of a transparent material.

8. The device of claim 1, wherein an air inflow pipe passage is installed at the water tank so as to receive air, and a mouth portion of the air inflow pipe passage is formed higher than the water surface.

9. The device of claim 1, wherein a bracket is installed above the water surface of the water tank and along an inner circumference of the water tank, and a filter member is engaged to the bracket so as to cover the inside of the water tank.

10. The device of claim 2, wherein a heater for heating water and a cooling coil for cooling water are installed inside the water tank.

11. The device of claim 2, wherein a drain unit is installed at the bottom of the water tank so as to discharge water.

12. The device of claim 2, wherein the dry filter is installed in such a way that a filter member is inserted in the inside of a housing which is made of a transparent material.
